(19) United States
(12) Patent Application Publication
(10) Pub. No.: US 2007/0144727 A1
(43) Pub. Date: Jun. 28, 2007

(54) Air conditioner for vehicle

(75) Inventors: Shunsaku Hirayama, Kariya-city (JP); Hideo Asano, Gifu-city (JP); Yasuhiro Mizuno, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/644,021

(22) Filed: Dec. 21, 2006

(30) Foreign Application Priority Data
Dec. 22, 2005 (JP) 2005-370104

(51) Int. Cl. B60H 3/00; B60H 1/00

(52) U.S. Cl. 165/203; 165/42

(57) ABSTRACT

An air conditioner for a vehicle has an air conditioning casing for defining therein a passage of air, a heating heat exchanger for heating air, and an air mixing door at an air upstream side of the heating heat exchanger to adjust an air volume ratio between air passing the heating heat exchanger and air passing a cool air bypass passage. In an air mixing state where the air mixing door is positioned at a substantially intermediate position between a maximum bypass position and a maximum heating position, additional air flow is compulsorily caused at a generation end of an interface between cool air and warm air in a cool-warm air mixing space, where cool air supplied through the cool air bypass passage and warm air heated by the heating heat exchanger and supplied through a warm air passage are mixed.

### CROSS REFERENCE TO RELATED APPLICATION

This application is based on a Japanese Patent Application No. 2005-370104 filed on Dec. 22, 2005, the disclosure of which is incorporated herein by reference.

### FIELD OF THE INVENTION

The present invention relates to an air conditioner for a vehicle, and more particularly to an air mixing type air conditioner for a vehicle, in which temperature is conditioned by an adjustment of a mixing ratio between cool air and warm air via an air mixing door.

### BACKGROUND OF THE INVENTION

Generally, with reference to FIG. 26, an air conditioning unit 10 of an air conditioner for a vehicle includes an air conditioning casing 11 which defines therein a passage of air-conditioning air, an evaporator 12 (heat exchanger for cooling) arranged in the air conditioning casing 11 to cool air-conditioning air, and a heater core 13 (heat exchanger for heating) arranged at an air downstream side of the evaporator 12 to heat air having passed the evaporator 12.

Moreover, the air conditioning unit 10 is provided with a cool air bypass passage 15, through which air having passed through the evaporator 12 flows to bypass the heater core 13, an air mixing door 16 which is arranged between the evaporator 12 and the heater core 13 to adjust an air volume ratio between air passing the heater core 13 and air passing the cool air bypass passage 15, and a cool-warm air mixing space 19 in which cool air supplied through the cool air bypass passage 15 and warm air heated by the heater core 13 and supplied through a warm air passage 18 are mixed.

A defroster opening 20, a face opening 22, and a foot opening 23 are sequentially arranged from the side of the cool air bypass passage 15 to the side of the warm air passage 18, as blowing openings through which mixed air from the cool-warm air mixing space 19 is blown outwards into a passenger compartment of the vehicle.

In this case, the air conditioning unit 10 can be provided with a bi-level blowing-out mode (shown in FIG. 26), where the air mixing door 16 is arranged at an intermediate position between a maximum bypass position and a maximum heating position and the face opening 22 and the foot opening 23 are opened. At the bi-level blowing mode, a temperature distribution of keeping the head (of passenger) cool and the feet (of passenger) warm is provided.

However, in the case where the air conditioning unit 10 shown in FIG. 26 is set at the bi-level blowing mode, cool air flows to the face opening 22 and warm air flows to the foot opening 23 before cool air and warm air are adequately mixed in the cool-warm air mixing space 19. Therefore, an up-down-direction temperature difference becomes larger than required.

In order to make appropriate the up-down-direction temperature difference at a face blowing-out port and a foot blowing-out port in a bi-level blowing mode, as disclosed in JP-2001-1743A, an air conditioning unit is provided with a rib as an air-mixing promoting member which protrudes from an inner wall surface of the air conditioning unit. In this case, air flow having passed a heater core is peeled off an inner wall surface of an air conditioning casing and forcedly changed in the flow direction thereof, so that the mixing between the air flow and cool air having passed an evaporator is improved.

Similarly, as a mixing promoting method, an air conditioning unit can be provided with a rib as an air mixing promoting member which protrudes from an air mixing door.

Moreover, as another mixing promoting method disclosed in JP-2005-306166A, a communication hole is provided at a turning shaft of an air mixing door. Cool air is jetted through the communication hole to bypass a mixing part of cool air and warm air. Thus, the mixing is promoted.

However, in the case where the rib as the air mixing promoting member protrudes from the inner wall surface of the air conditioning unit or the air mixing door with reference to JP-2001-1743A, the rib itself constructs a resistance member to cause problems of an increase in pressure loss, an augment in noise level, a generation of abnormal noise, a decrease in air volume, and the like.

Furthermore, in the case of JP-2005-306166A, because a jet direction and a flow velocity of bypass air are uniformly determined by an opening degree of the air mixing door, a jet angle and a jet flow velocity suitable for improving the mixing can be only obtained in a part of the air mixing region.

Furthermore, recently, because a miniaturization of the air conditioning unit is developed with an increase of a passenger space of the vehicle, it is desirable to adequately mix cool air and warm air in a narrow region.

### SUMMARY OF THE INVENTION

In view of the above-described disadvantages, it is an object of the present invention to provide an air conditioner for a vehicle, in which mixing between cool air and warm air is improved in a whole air mixing region substantially without increasing a ventilation resistance.

According to the present invention, an air conditioner for a vehicle has an air conditioning casing for defining therein a passage of air, a heating heat exchanger which is arranged in the air conditioning casing to heat air, and an air mixing door which is arranged at an air upstream side of the heating heat exchanger to adjust an air volume ratio between air passing the heating heat exchanger and air passing a cool air bypass passage defined in the air conditioning casing. Air flows through the cool air bypass passage to bypass the heating heat exchanger. The air conditioning casing has therein a cool-warm air mixing space, in which cool air supplied through the cool air bypass passage and warm air heated by the heating heat exchanger and supplied through a warm air passage are mixed. The air conditioning casing has a defroster opening, a face opening and a foot opening, through which mixed air from the cooling-warm air mixing space flows outward into a passenger compartment of the vehicle. The defroster opening, the face opening and the foot opening are positioned from a side of the cool air bypass passage to a side of the warm air passage. In an air mixing state where the air mixing door is positioned at a substantially intermediate position between a maximum bypass position and a maximum heating position, an additional air flow is compulsorily caused in the vicinity of a generation end of an interface between the cool air and the warm air which is generated in the cooling-warm air mixing space.

When the cool air and the warm air strike against each other, the interface (K) is generated between the cool air and the warm air. A position of a region where a turbulence (i.e., colliding air flows) generated by the collision of the air flows is liable to mix, is different from a position of the interface. Therefore, it is difficult to substantially mix the cool air and the warm air simply by making the cool air and the warm air colliding with each other.

According to the present invention, the additional air flow is compulsorily caused in the vicinity of the generation end, so that the turbulence of the air flow becomes large in area and is pushed up to be carried on the interface. Thus, the mixing of air flow can be improved, unlike the case where ribs are provided as resistance members.

Thereby, the temperature distribution in the blowing-out ports becomes even and the temperature difference among the blowing-out ports becomes liable to be controlled, so that a favorable performance of temperature control can be obtained at all of the blowing-out modes of the air conditioner.

Preferably, the air flow is jetted from a shaft portion of the air mixing door. Thus, a blowing-out direction of the air flow can be automatically varied according to the turning of the air mixing door. Therefore, the construction of the air conditioner can become simple, thus reducing the cost.

More preferably, the air conditioner has a jet flow blowing-out member which is provided with a plurality of small holes (jet holes), through which the air flow is jetted.

Thus, the turbulence of air flow can be provided via a small air quantity, while a required high flow velocity can be obtained. In this case, the jet holes can be formed with little influence on the strength of the jet blow-off pipe.

More preferably, air around the generation end of the interface between the cool air and the warm air which is generated in the cool-warm air mixing space 19 is sucked, to cause the additional air flow at the generation end.

In this case, by sucking air in the vicinity of the interface between cool air and warm air generated in the cool- and warm air mixing space, and hence in the vicinity of the generation end (upstream end) as possible, the turbulence of the air flow is increased in area and pushed up to be carried on the interface. Therefore, the mixing of the air flow can be improved. Because the angle of cool air flowing into the cool-warm air mixing space is varied according to the opening degree of the air mixing door, it is effective to make the suction direction variable in response to the turn position of the air mixing door.

Thus, unlike the case where the ribs are provided as the resistance members, the mixing between cool air and warm air can be improved substantially without increasing the ventilation resistance. Thereby, the temperature distribution in the blowing-out ports becomes even and the temperature difference among the blowing-out ports becomes liable to be controlled. Accordingly, a favorable performance of temperature control in all of the blowing-out modes can be provided.

More preferably, the air conditioner has a turbulence generating member which is arranged at the interface between the cool air and the warm air generated in the cool-warm air mixing space. The turbulence generating member causes the additional air flow at the generation end of the interface.

In this case, by arranging the turbulence generating member at the interface between cool air and warm air generated in the cool-warm air mixing space, the turbulence of the air flow is increased in area and the turbulence of the air flow is generated at the interface. Thus, the adequate mixing of the air flow can be obtained.

Thus, unlike the case where the ribs are provided as the resistance members, the mixing between cool air and warm air can be improved substantially without increasing the ventilation resistance. Thereby, the temperature distribution in the blowing-out ports becomes even and the temperature difference among the blowing-out ports becomes liable to be controlled. Accordingly, a favorable performance of temperature control in all of the blowing-out modes can be provided.

### BRIEF DESCRIPTION OF THE DRAWINGS

Other objects, features and advantages of the present invention will become more apparent from the following detailed description made with reference to the accompanying drawings, in which:

FIG. 1 is a longitudinally cross-sectional view showing an air conditioning unit in a state of a bi-level blowing-out mode according to a first embodiment of the present invention;

FIG. 2A is a front view showing a jet flow blowing-out pipe according to the first embodiment, and FIG. 2B is an enlarged cross-sectional view taken along a line IIB-IIB in FIG. 2A;

FIG. 3 is a longitudinally cross-sectional view showing a state where an air mixing door of the air conditioning unit in FIG. 1 is moved to a hot side according to the first embodiment;

FIG. 4 is a longitudinally cross-sectional view showing a state where the air mixing door of the air conditioning unit in FIG. 1 is moved to a cool side according to the first embodiment;

FIG. 5 is an isothermal diagram showing results of model experiments of a cool-warm air mixing space in the case where a blowing-out of a jet flow is absent;

FIG. 6 is an isothermal diagram showing results of model experiments of the cool-warm air mixing space in the case where the blowing-out of the jet flow is provided according to the first embodiment;

FIG. 7 is an uniformly varying wind velocity diagram showing results of model experiments of the cool-warm air mixing space in the case where the blowing-out of the jet flow is absent;

FIG. 8 is an uniform varying wind velocity diagram showing results of model experiments of the cool-warm air mixing space in the case where the blowing-out of the jet flow F is provided according to the first embodiment;

FIG. 9 is an isothermal diagram at a face blowing-out port in the case where the blowing-out of the jet flow is absent;

FIG. 10 is an isothermal diagram at the face blowing-out port in the case where the blowing-out of the jet flow is provided according to the first embodiment;

FIG. 11 is a graph showing a relationship between a blowing-out temperature and a height-direction position at a width-direction middle of the isothermal diagram of FIG. 9, and showing a relationship between a blowing-out temperature and a height-direction position at a width-direction middle of the isothermal diagram of FIG. 10;

FIG. 12 is a graph showing relationships respectively between an opening degree of the air mixing door and blowing-out air temperature at foot and face blowing-out ports in the bi-level blowing mode to indicate a difference between a presence of the air flow and an absence of the jet flow;

FIG. 13 is a longitudinally cross-sectional view showing an air conditioning unit according to a second embodiment of the present invention;

FIG. 14A is a graph showing an intermittent flow as a blowing-out manner of a jet flow according to a third embodiment of the present invention, FIG. 14B is a graph showing a pulsating flow as the blowing-out manner of the jet flow according to the third embodiment;

FIG. 15 is a longitudinally cross-sectional view showing an air conditioning unit according to a fourth embodiment of the present invention;

FIG. 16 is a longitudinally cross-sectional view showing an air conditioning unit according to a fifth embodiment of the present invention;

FIG. 17 is a longitudinally cross-sectional view showing an air conditioning unit according to a sixth embodiment of the present invention;

FIG. 18 is a longitudinally cross-sectional view showing an air conditioning unit according to a seventh embodiment of the present invention;

FIG. 19A is a front view showing a jet flow blowing-out pipe according to an eighth embodiment of the present invention, FIG. 19B is an enlarged cross-sectional view taken along a line XIXB-XIXB in FIG. 19A, and FIG. 19C is an enlarged cross-sectional view taken along a line XIXC-XIXC in FIG. 19A;

FIG. 20A is a front view showing a jet flow blowing-out pipe according to a ninth embodiment of the present invention, and FIG. 20B is an enlarged cross-sectional view taken along a line XXB-XXB in FIG. 20A;

FIG. 21 is a longitudinally cross-sectional view showing an air conditioning unit according to a tenth embodiment of the present invention;

FIG. 22 is a longitudinally cross-sectional view showing an air conditioning unit according to an eleventh embodiment of the present invention;

FIG. 23 is a longitudinally cross-sectional view showing an air conditioning unit according to a twelfth embodiment of the present invention;

FIG. 24 is a perspective view showing a moving-type turbulence generating member in FIG. 23;

FIG. 25 is a longitudinally cross-sectional view showing an air conditioning unit where an evaporator is positioned substantially horizontally according to other embodiment of the present invention; and

FIG. 26 is a longitudinally cross-sectional view showing an air conditioning unit of an air conditioner for a vehicle in a state of a bi-level blowing-out mode according to a related art.

### DETAILED DESCRIPTION OF THE EXAMPLED EMBODIMENTS

### First Embodiment

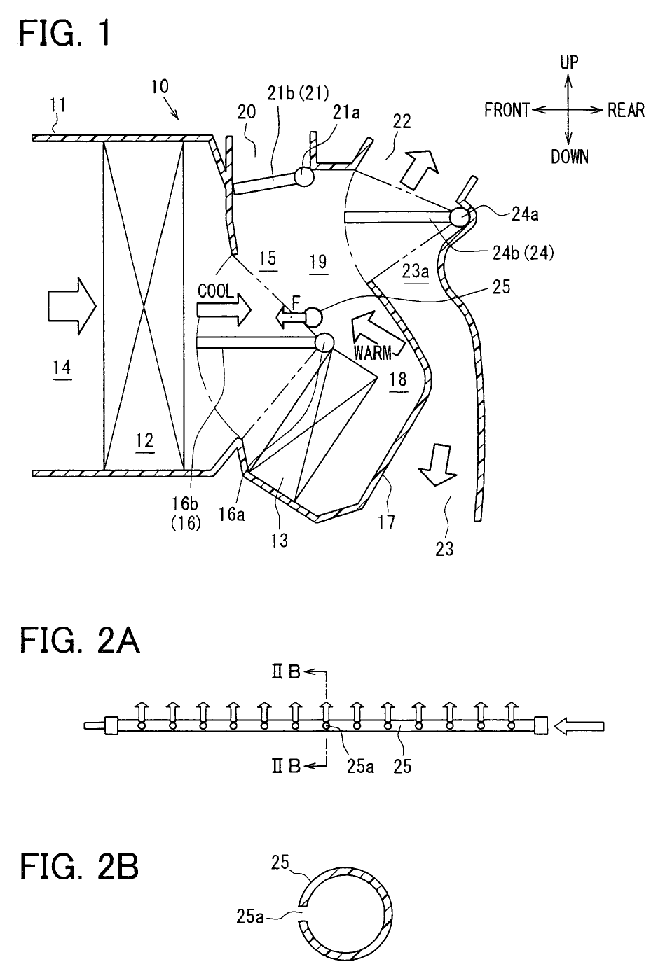

An air conditioner for a vehicle according to a first embodiment of the present invention will be described with reference to FIGS. 1-12. A ventilation system of the air conditioner mainly includes an air conditioning unit 10 and an air blower unit 30 (not shown in FIG. 1). FIG. 1 shows the air conditioning unit 10 in a state of a bi-level blowing-out mode.

In the description of the present invention (for example, as shown in FIG. 1), the up-down direction and the front-rear direction respectively represent the vehicle up-down direction and the vehicle front-rear direction.

The air conditioning unit 10 can be positioned at a lower side of an instrument panel in a passenger compartment of the vehicle, and arranged at a substantial middle of the vehicle left-right direction. In this case, the air blower unit 30 can be offset toward an assistant seat of the vehicle.

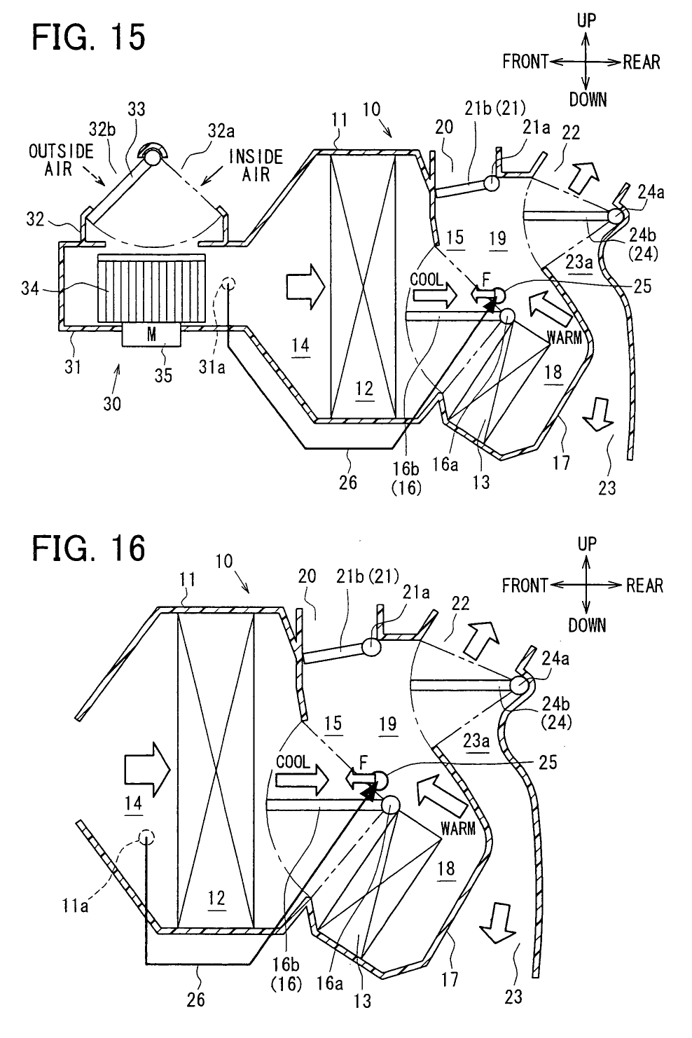

With reference to FIG. 15 (described later), the air blower unit 30 includes an inside-outside air switching box 32 into which inside air (air in passenger compartment) and outside air (air outside passenger compartment) are switched to be introduced, and an air blower member which blows air introduced from the inside-outside air switching box 32.

The inside-outside air switching box 32 has an inside air inlet 32a for an introduction of inside air, an outside air inlet 32b for an introduction of outside air, an inside-outside air switching door 33 for switching the inlets 32a and 32b between opening and closing, a door driving apparatus (not shown) and the like.

The air blower member is provided with an electric motor 35, a scroll casing 31, and a centrifugal multi-blade fan 34 (sirocco fan) which is arranged at a substantial middle of the scroll casing 31. The centrifugal multi-blade fan 34 is driven by the electric motor 35 to rotate.

In this case, the air conditioning unit 10 has an evaporator 12 (heat exchanger for cooling) and a heater core 13 (heat exchanger for heating), both of which are housed integrally in a single air conditioning casing 11.

The air conditioning casing 11 can have a division surface in the vehicle up-down direction shown in FIG. 1 to be divided into a right side portion and a left side portion. The air conditioning casing 11 can be molded by a resin such as polypropylene, which has an elasticity to some degree and is excellent in strength.

The right side portion and the left side portion of the air conditioning casing 11 accommodates therein the evaporator 12, the heater core 13, doors 16, 21 and 24 (described later), a jet flow blowing-out member 25 (e.g., jet flow blowing-out pipe) and the like, and thereafter are integrally joined to each other by fastening unit such as metallic spring clip, screw and the like to construct the air conditioning casing 11. The air conditioning unit 10 can be arranged in the vehicle with respect to the front-rear direction and the up-down direction of the vehicle as shown in FIG. 1.

The air conditioning casing 11 has a casing part (not shown) at a forward-most portion thereof. An air inflow portion 14 is arranged at the casing part. Air-conditioning air blown from the air blower unit 30 flows into the air inflow portion 14. Because the air inflow portion 14 is to be connected to an air outlet of the air blower unit 30 arranged at the front side of the assistant seat, the air inflow portion 14 is opened at a part of the side surface of the air conditioning casing 11 which is at the side of the assistant seat.

The evaporator 12 is arranged in the air conditioning casing 11 and positioned at an immediately rear side of the air inflow portion 14, in such a manner that the evaporator 12 intersects the whole region of the air passage through which air is blown into the air conditioning casing 11 from the air blower unit 30.

As well known, the evaporator 12 absorbs vaporization latent heat of refrigerant in refrigerating cycle from air-conditioning air (i.e., air which will be blown into passenger compartment to air-condition passenger compartment) to cool air-conditioning air. In this case, the evaporator 12 can have a thin shape in the vehicle front-rear direction, and is mounted in the air conditioning casing 11 with a longitudinal direction of the evaporator 12 facing the vehicle left-right direction as shown in FIG. 1.

The evaporator 12, being of a well-known laminated type, has multiple corrugated fins and multiple flat tubes which are stacked and integrated by brazing or the like. In this case, each of the corrugated fins is arranged between the adjacent flat tubes. The flat tube can be constructed of two metallic thin plates of aluminum or the like which are bonded to together.

The heater core 13 is arranged at an air downstream side (vehicle rear side) of the evaporator 12, and positioned adjacently to the evaporator 12 with a predetermined interval therebetween. The heater core 13 heats cool air having passed the evaporator 12. Engine cooling water (hot water) having a high temperature flows in the heater core 13, to heat air as a heat source.

Similarly to the evaporator 12, the heater core 13 has a thin shape in the vehicle front-rear direction, and is mounted in the air conditioning casing 11 with the longitudinal direction of the heater core 13 facing the vehicle left-right direction. The heater core 13 can have multiple corrugated fins and multiple flat tubes which are stacked and integrated by brazing or the like. In this case, each of the corrugated fins is arranged between the adjacent flat tubes. The flat tube can be constructed of a metallic thin plate of aluminum or the like which is integrally bonded by welding or the like.

A cool air bypass passage 15, through which air (cool air) flows to bypass the heater core 13, is arranged at the vehicle upper side of the heater core 13 in the air conditioning casing 11. The air mixing door 16 having a substantially flat plate shape is arranged between the heater core 13 and the evaporator 12 in the air conditioning casing 11, to regulate (adjust) an air volume ratio between warm air heated by the heater core 13 and cool air (that is, cool air flowing through cool air bypass passage 15) bypassing the heater core 13.

The air mixing door 16 includes a shaft portion 16a (turning shaft) which can be arranged in a substantially horizontal direction, and a base plate portion 16b integrated with the shaft portion 16a. The base plate portion 16b is rotatable together with the shaft portion 16a in the vehicle up-down direction. The air mixing door 16 constitutes a temperature adjusting unit for adjusting a blowing-out air temperature by a modification of the air volume ratio.

The shaft portion 16a is rotatably supported at the air conditioning casing 11. An end of the shaft portion 16a projects outwards from the air conditioning casing 11 to be joined to a linkage (not shown), so that the shaft portion 16a is rotatably operated by a temperature control mechanism (actuator such as servomotor) of the air conditioner.

The air conditioning casing 11 has a wall surface 17, which extends in the substantially up-down direction of the vehicle in the air conditioning casing 11 and is positioned at the air downstream side (vehicle rear side) of the heater core 13. In this case, a predetermined interval is arranged between the heater core 13 and the wall surface 17.

A warm air passage 18 is provided substantially between the wall surface 17 and the heater core 13. Air from the heater core 13 passes the warm air passage 18 in such a manner that air is guided upward from the immediately rear side of the heater core 13. The downstream side (upper side) of the warm air passage 18 and the cool air bypass passage 15 are communicated with (merge with) each other at the upper side of the heater core 13, to generate thereat a cool-warm air mixing space 19 where cool air and warm air are mixed.

The air conditioning casing 11 has a defroster opening 20 which is opened at a vehicle front portion of an upper surface of the air conditioning casing 11. Conditioned air (temperature of which has been conditioned) from the cool-warm air mixing space 19 can flow into the defroster opening 20, which is opened and closed by a defroster door 21.

The defroster door 21 has a shaft portion 21a rotatably supported at the air conditioning casing 11, and a base plate portion 21b integrated with the shaft portion 21a. The defroster opening 20 is connected to a defroster blowing-out port through a defroster duct (not shown), so that air is blown out from the blowing-out port toward an inner surface of a vehicle front window.

Moreover, the air conditioning casing 11 has a face opening 22 and an inlet hole 23a which are arranged at the downstream side of the cool-warm air mixing space 19. A foot opening 23 of the air conditioning casing 11 is provided at the downstream side of the inlet hole 23a. The face opening 22 and the inlet hole 23a are selectively opened and closed by a face-foot switching door 24.

That is, the face opening 22 and the foot opening 23 can be opened and closed by the face-foot switching door 24. The face-foot switching door 24 has a shaft portion 24a rotatably supported at the air conditioning casing 11, and a base plate portion 24b integrated with the shaft portion 24a.

The defroster door 21 and the face-foot switching door 24 constitute a door unit for switching blowing-out modes, and are connected to a linkage (not shown) to be interlockingly operated by a blowing-out mode switching mechanism (actuator such as servomotor). The face opening 22 is connected to the face blowing-out port, which is arranged at the upper side of a substantial middle of the instrument panel, through a face duct (not shown). Thus, cool air can be mainly blown toward the upper portion of a passenger in the passenger compartment from the face blowing-out port.

The foot opening 23 is connected to the foot blowing-out port through a foot duct (not shown) so that warm air can be blown toward the lower portion of the passenger from the foot blowing-out port.

As described above, the doors 16, 21 and 24 respectively have the shaft portions 16a, 21a and 24a, and respectively have the base plate portions 16b, 21b and 24b. The shaft portions 16a, 21a and 24a can be provided with the substantially same length. Each of the base plate portions 16b, 21b, and 24b can be constructed of a door plate made of a resin or a metal. The front and back surfaces of the door plate respectively have elastic sealing members which are made of urethane foam or the like and adhered thereto, for example.

FIG. 2A is a front view showing the jet flow blowing-out pipe 25, and FIG. 2B is an enlarged cross-sectional view taken along the line IIB-IIB in FIG. 2A. With reference to FIGS. 2A and 2B, the jet flow blowing-out pipe 25 has multiple jet holes 25a, through which air flow is jetted. The jet flow blowing-out pipe 25 is arranged in the vicinity of the cool-warm air mixing space 19, as shown in FIG. 1. Thus, in an air mixing state where the air mixing door 16 is operated to an intermediate position between a maximum bypass position (where cool air bypass passage 15 is opened to a maximum degree) and a maximum heating position (where warm air passage 18 is opened to a maximum degree), air flow is jetted toward the vicinity of an end (generation end), at which an interface K between cool air and warm air caused in the cool-warm air mixing space 19 is generated.

The jet flow blowing-out pipe 25 is rotatably supported at the air conditioning casing 11 and positioned at the immediately upper side of the shaft portion 16a of the air mixing door 16. The jet flow blowing-out pipe 25 is provided with the multiple (e.g., 13 as shown in FIG. 2A) jet holes 25a, each of which is a small hole. The jet hole 25a can have a diameter of about 1 mm, for example.

The jet holes 25a are juxtaposed in the longitudinal direction of the jet flow blowing-out pipe 25, with a predetermined pitch (e.g., about 10 mm). In this case, the jet flow blowing-out pipe 25 provided with the jet holes 25a is arranged over the whole interior width of the air conditioning casing 11 in the vehicle left-right direction.

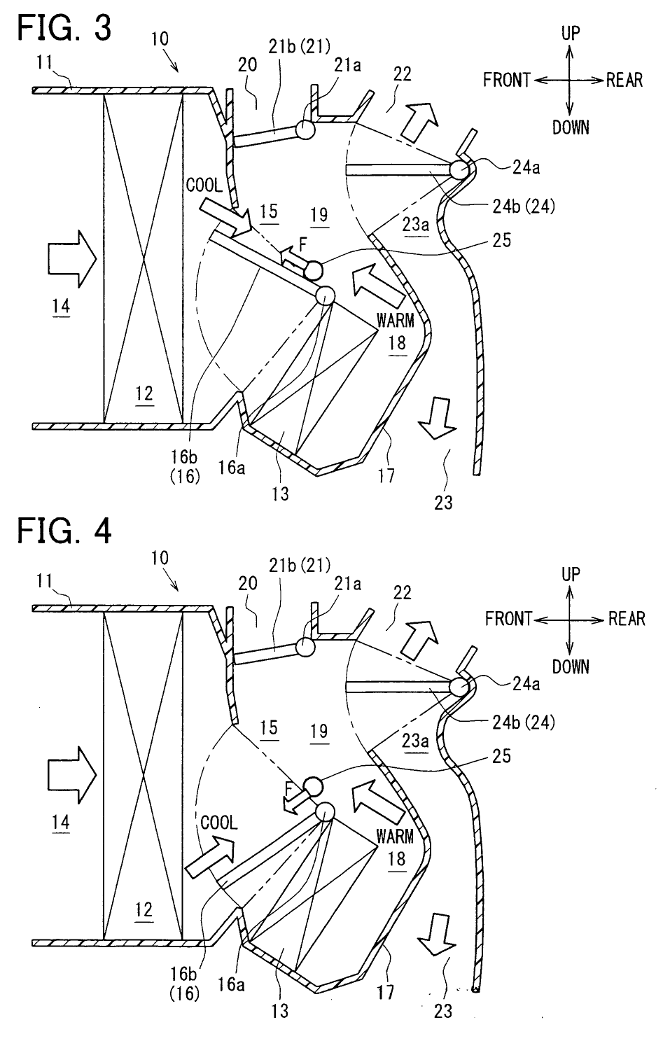

According to this embodiment, a jet flow F (air flow) is blown out from the jet flow blowing-out pipe 25 in such a manner that the jet flow F is opposite to cool air flowing into the cool-warm air mixing space 19, as shown in FIGS. 1, 3 and 4. FIG. 3 is a longitudinal cross-sectional view showing the air conditioning unit 10 in a state where the air mixing door 16 is moved to a hot side, with respect to the air conditioning unit 10 shown in FIG. 1. FIG. 4 is a longitudinal cross-sectional view showing the air conditioning unit 10 in a state where the air mixing door 16 is moved to a cool side.

As shown in FIGS. 3 and 4, because the direction of a main flow of cool air flowing into the cool-warm air mixing space 19 varies in response to a turn position of the air mixing door 16, the jet flow blowing-out pipe 25 is turned corresponding to the turning of the air mixing door 16 so that an opposing angle between the main flow of cool air and the jet flow F is equal to or less than 30 degrees substantially at all times. Moreover, a flow velocity of the jet flow F is set as about one-three times a wind velocity of cool air which is opposed to the jet flow F.

Next, the operation of the vehicle air conditioner will be described.

As well known, the vehicle air conditioner has an air conditioning control device (not shown), into which operation signals from various operating parts provided at an air conditioning operation panel and sensor signals from various sensors for an air conditioning control are input. The air volume of the blower and the positions of the doors 16, 21 and 24, and the like are controlled by an output signal from the control device. Thus, one of a face blowing-out mode, the bi-level blowing-out mode, a foot blowing-out mode, a foot-defroster blowing-out mode and a defroster blowing-out mode is selected and set.

FIG. 1 shows the state of the bi-level blowing-out mode. When the face-foot switching door 24 is set in a state where both the face opening 22 and the inlet hole 23a (communicated with foot opening 23) are opened, the bi-level blowing mode is obtained. In this case, the air mixing door 16 is positioned at the intermediate position between the maximum bypass (cooling conditioning) position and the maximum heating (heating conditioning) position. That is, the air mixing door 16 is operated at an air mixing state.

In this state, air blown from the air blower unit 30 flows into the air conditioning unit 10 through the air inflow portion 14 to be cooled by the evaporator 12 to become cool air. The air mixing door 16 divides cool air into air flowing through the cool air bypass passage 15 and air heated by the heater core 13.

Warm air having heated by the heater core 13 rises in the warm air passage 18, and then flows toward the cool-warm air mixing space 19. In the cool-warm air mixing space 19, cool air from the cool air bypass passage 15 and warm air from the warm air passage 18 strike against each other to be mixed.

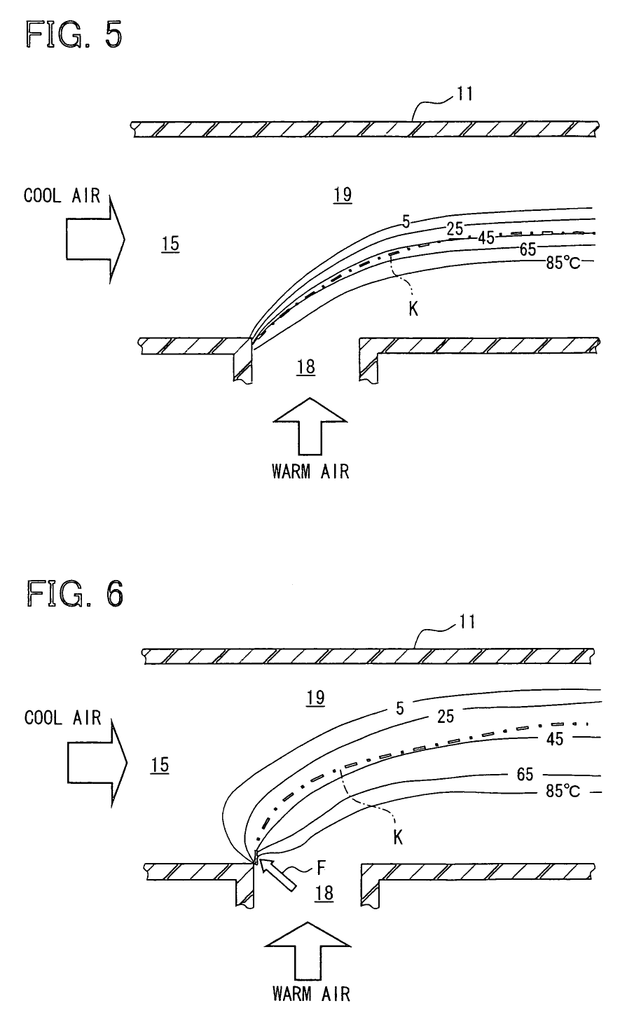

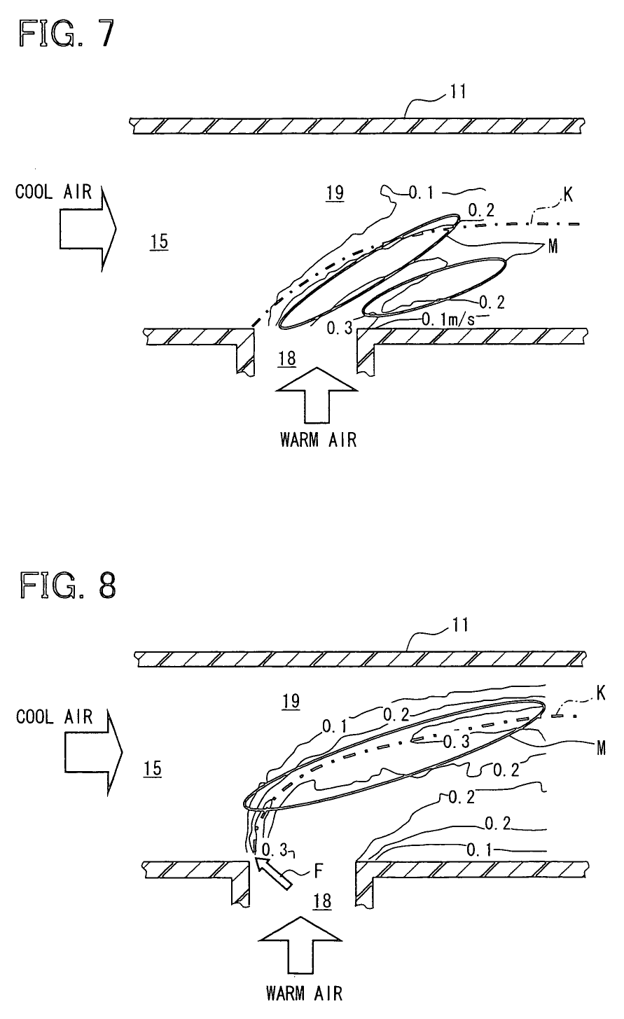

FIG. 5 is an isothermal diagram showing results of model experiments of the cool-warm air mixing space 19 in the case where the blowing-out of the jet flow F is absent. FIG. 6 is an isothermal diagram showing results of model experiments of the cool-warm air mixing space 19 in the case where the blowing-off of the jet flow F is provided. FIG. 7 is a uniformly varying wind velocity diagram showing results of model experiments of the cool-warm air mixing space 19 in the case where the blowing-off of the jet flow F is absent. FIG. 8 is a uniformly varying wind velocity diagram showing results of model experiments of the cool-warm air mixing space 19 in the case where blowing-off of the jet flow F is provided.

As shown in FIG. 5, when cool air and warm air strike (collide) against each other, the interface K is generated between cool air and warm air. As shown in FIG. 7, the position of the interface K is different from the position of the region where a turbulence M (that is, air flows having collided) generated by the collision of air flows readily mixes. Therefore, it is found that the adequate mixing is not obtained via the simple collision between cool air and warm air.

According to this embodiment, as shown in FIGS. 6 and 8, the jet flow F (air flow) is jetted toward the interface K between cool air and warm air generated in the cool-warm air mixing space 19. Moreover, in this case, the jet flow F (air flow) is ejected (jetted) toward the vicinity of the generation end of the interface K (i.e., upstream end of interface K), as possible. Thus, the turbulence M of air flow becomes large in area, and is pushed up to be carried on the interface K. Therefore, the adequate mixing of air flows can be obtained.

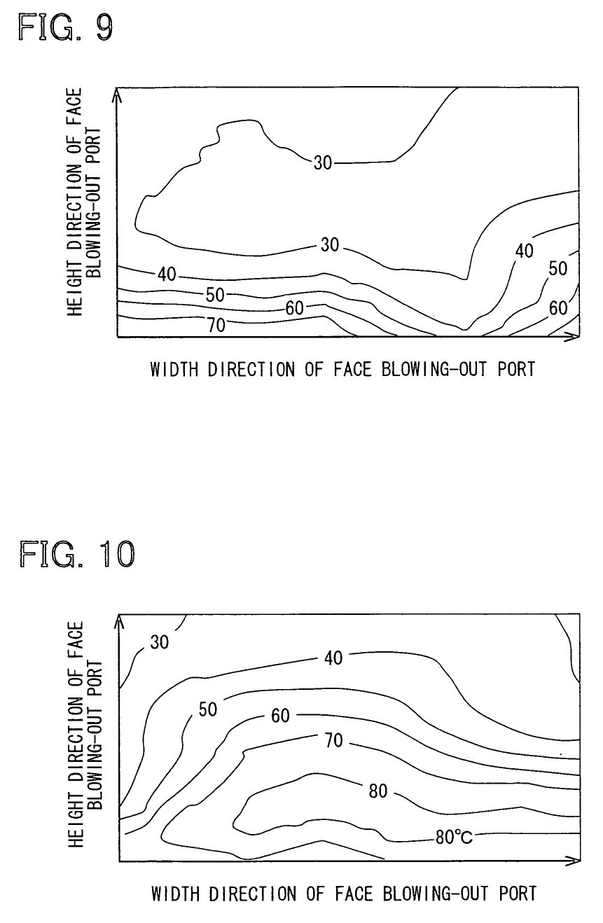

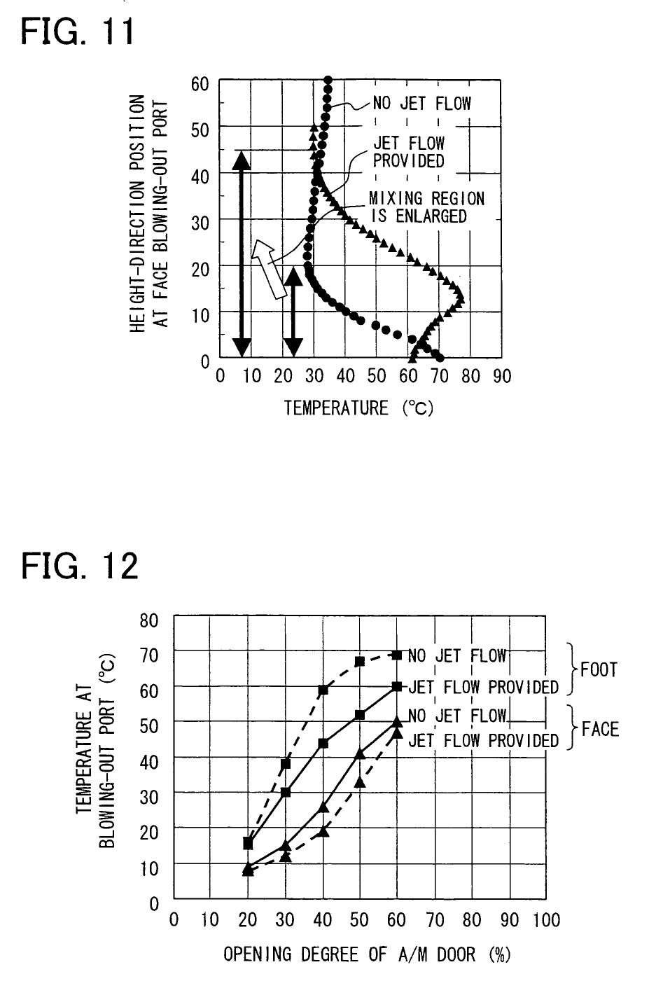

FIG. 9 is an isothermal diagram at the face blowing-out port in the case where the blowing-out of the jet flow F is absent. FIG. 10 is an isothermal diagram at the face blowing-out port in the case where the blowing-out of the jet flow F is provided. FIG. 11 is a graph showing the relationship between a blowing-out air temperature and a height-direction position at the face blowing-out port corresponding to a width-direction middle thereat of the isothermal diagram of FIG. 9, and that of FIG. 10.

In the case where the blowing-out of the jet flow F is absent, the mixing between cool air and warm air is not improved so that cool air and warm air are separated from each other even in the blowing-out port to result in a large temperature difference.

According to this embodiment, the jet flow F is provided to move the turbulence M to the interface K between cool air and warm air, so that the mixing region is enlarged and the temperature distribution in the blowing-out port is decreased even at the single blowing-out mode.

FIG. 12 is a graph showing the relationship between the blowing-out air temperature at the foot blowing-out port 23 and the opening degree of the air mixing door 16 (A/M door) in the bi-level blowing mode, and that between the blowing-out air temperature at the face blowing-out port 22 and the opening degree of the air mixing door 16 in the bi-level blowing mode. Moreover, FIG. 12 shows a difference between the case of the presence of the jet flow F and the case of the absence of the jet flow F.

Because the mixing between cool air and warm air is not improved in the case where the jet flow F is absent, the temperature difference between the face blowing-out port 22 and the foot blowing-out port 23 becomes large in the bi-level blowing mode, where air is blown out from the face blowing-out port 22 and the foot blowing-out port 23. While not being shown, the temperature difference between the defroster blowing-out port 20 and the foot blowing-out port 23 becomes large also in the foot blowing mode and in the foot-defroster blowing mode, where air is blown out from the defroster blowing-out port 20 and the foot blowing-out port 23.

According to this embodiment, the mixing can be improved, by providing the jet flow F to move the turbulence M to the position of the interface K between cool air and warm air. Therefore, the temperature difference among the blowing-out ports is decreased and an appropriate control can be performed. Since the states of the other blowing-out modes are well-known, the description thereof is omitted.

According to this embodiment, in the air mixing state where the air mixing door 16 is operated to the intermediate position between the maximum bypass position and the maximum heating position, air flow (jet flow F) is jetted toward the vicinity of the end (generation end) of the interface K, at which the interface K between cool air and warm air caused in the cool-warm air mixing space 19 is generated.

Thus, unlike the case where ribs are provided as resistance members, it is capable to improve the mixing between cool air and warm air without increasing the ventilation resistance. Therefore, the temperature distribution in the blowing-out ports becomes even and the temperature difference among the blowing-out ports becomes liable to be controlled, so that a satisfactory performance of temperature control can be obtained at all of the blowing-out modes.

Moreover, air flow (jet flow F) is jetted in such a manner that the air flow is opposite to cool air flowing into the cool-warm air mixing space 19. According to this embodiment, the flow direction of cool air is the main flow direction, and warm air is mixed with being substantially perpendicular to the main flow. Thus, the interface K extends toward a trailing flow side along the main flow. Therefore, it is effective to jet the air flow in such a manner that the air flow is opposed to cool air of the main flow.

According to this embodiment, the opposing angle between cool air and the jet flow F is set about 0-30 degrees. The flow velocity of the jet flow F is set about 1-3 times the flow velocity of cool air. Thus, the mixing can be improved.

Moreover, the jet direction of the air flow can be changed according to the turn position of the air mixing door 16. Because the angle of cool air flowing into the cool-warm air mixing space 19 varies according to the opening degree of the air mixing door 16, it is effective to make the blowing-out direction of the jet flow F variable corresponding to the turn position of the air mixing door 16.

Accordingly, the mixing between cool air and warm air can be improved over the whole air mix region, without increasing the ventilation resistance. In this case, the blowing-out direction can be varied interlockingly with the air mixing door 16. Alternatively, the variation of the blowing-out direction can be singly driven to be used in adjustment of the up-down-direction temperature difference. More alternatively, the blowing-out direction can be varied by swinging, for example.

According to this embodiment, the multiple small holes are provided to construct the jet holes 25a of the air flow (jet flow F). Thus, the high flow velocity required for generating the air flow turbulence M can be provided, even when the air volume is small. Moreover, because the jet flow blowing-out pipe 25 is provided with the multiple small holes as the jet holes 25a, the strength of the jet flow blowing-out pipe 25 can be substantially maintained.

### Second Embodiment

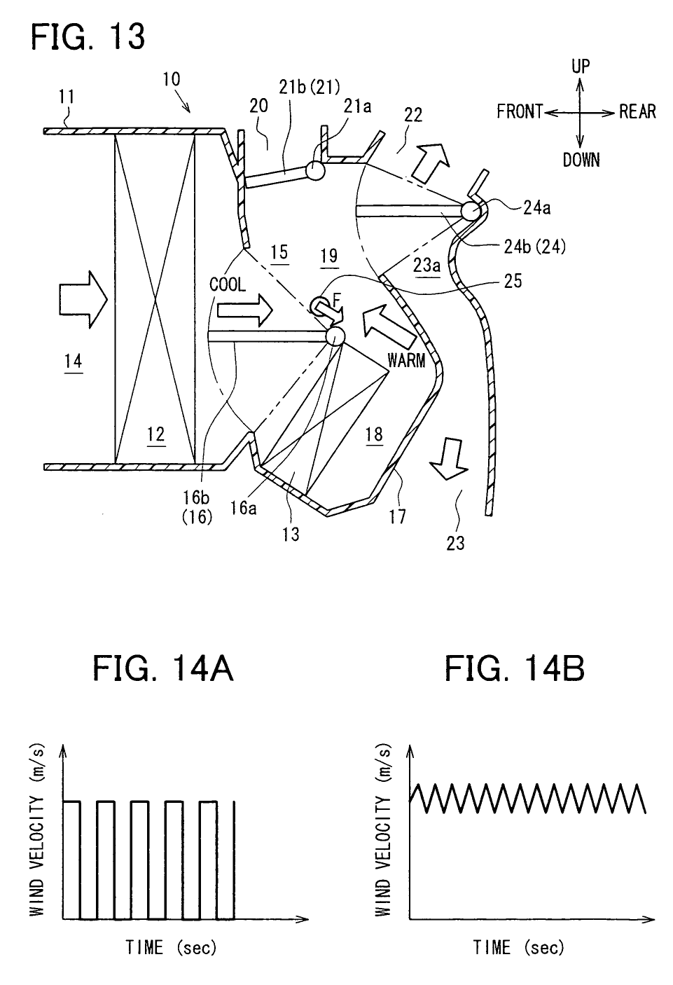

The air conditioning unit 10 according to a second embodiment of the present invention will be described with reference to FIG. 13. Differences between the second embodiment and the above-described embodiment will be explained.

In the second embodiment, the air flow (jet flow F) is jetted in such a manner that the air flow is opposite to warm air flowing into the cool-warm air mixing space 19. In this case, the flow direction of warm air is the main flow direction, and cool air is mixed with being substantially perpendicular to the main flow. Because the interface K extends toward the trailing flow side along the main flow, it is effective to jet the air flow in such a manner that the jet flow F is opposite to warm air of the main flow.

In this case, at the side of warm air, air is divided by the air mixing door 16 to pass through the heater core 13 and the warm air passage 18. While the air volume of warm air varies due to the opening degree of the air mixing door 16, the flow direction of warm is substantially fixed. Therefore, in this case, it becomes unnecessary to change the jet direction of the jet flow F by turning the jet flow blowing-out pipe 25.

### Third Embodiment

The air conditioning unit 10 according to a third embodiment of the present invention will be described with reference to FIGS. 14A and 14B. Differences between the third embodiment and the above-described embodiments will be explained.

According to this embodiment, the air flow (jet flow F) is jetted in such a manner that the wind velocity (air flowing velocity) of the air flow is variable. The jet flow F can be blown out as an intermittent flow shown in FIG. 14A or a pulsating flow shown in FIG. 14B, so that the wind velocity is variable with the time elapsing.

Alternatively, the jet flow F can be also blown out as a steady flow having a constant wind velocity.

### Fourth Embodiment

The air conditioning unit 10 according to a fourth embodiment of the present invention will be described with reference to FIG. 15. Differences between the fourth embodiment and the above-described embodiments will be explained.

According to this embodiment, an air flow taking-out hole 31a is formed at a part of the scroll case 31 of the air blower unit 30. A branch ventilation passage member 26 (e.g., pipe) is provided to communicate the air flow taking-out hole 31a with the jet flow blowing-out pipe 25. Thus, air-conditioning air which is blown toward the air conditioning unit 10 can be guided to the jet flow blowing-out pipe 25 through the branch ventilation passage member 26, to be jetted from the jet holes 25a. Therefore, the air flow for the jet flow F can be readily obtained from the air blower unit 30.

### Fifth Embodiment

The air conditioning unit 10 according to a fifth embodiment of the present invention will be described with reference to FIG. 16. Differences between the fifth embodiment and the above-described embodiments will be explained.

According to this embodiment, an air flow taking-out hole 11a is provided at a part of the air conditioning casing 11 of the air blower unit 10. Thus, the branch ventilation passage member 26 (e.g., pipe) is provided to communicate the air flow taking-out hole 11a with the jet flow blowing-out pipe 25. Thus, air-conditioning air which flows toward the evaporator 12 can be guided to the jet flow blowing-out pipe 25 through the branch ventilation passage member 26, to be jetted from the jet holes 25a. Thereby, the air flow can be readily obtained even in the air blower unit 10.

Moreover, the branch ventilation passage member 26 can be made short and a part thereof can be integrated with the air conditioning casing.

### Sixth Embodiment

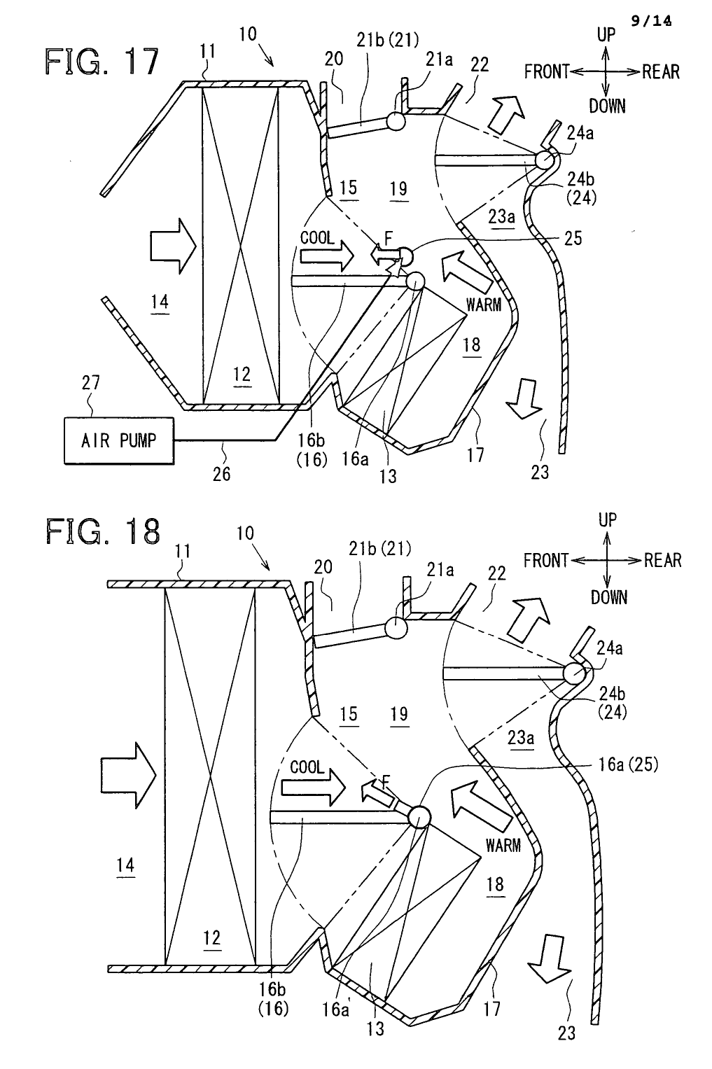

The air conditioning unit 10 according to a sixth embodiment of the present invention will be described with reference to FIG. 17. Differences between the sixth embodiment and the above-described embodiments will be explained.

According to this embodiment, air flow generated by an air flow generating source 27 of the exterior is guided to the jet flow blowing-out pipe 25 through the branch ventilation passage member 26 to be jetted from the jet holes 25a. In this case, the air flow generating source 27 such as an air pump can be provided at the exterior.

### Seventh Embodiment

The air conditioning unit 10 according to a seventh embodiment of the present invention will be described with reference to FIG. 18. Differences between the seventh embodiment and the above-described embodiments will be explained.

According to this embodiment, the air flow (jet flow F) is jetted from the turning shaft portion 16a of the air mixing door 16. Because the blowing-out direction of the jet flow F is automatically variable with the turning of the air mixing door 16, it becomes unnecessary to turn the jet flow blowing-Out pipe 25 interlockingly with the air mixing door 16. Therefore, the construction of the air conditioning unit 10 can become simple, thus reducing the cost.

### Eighth Embodiment

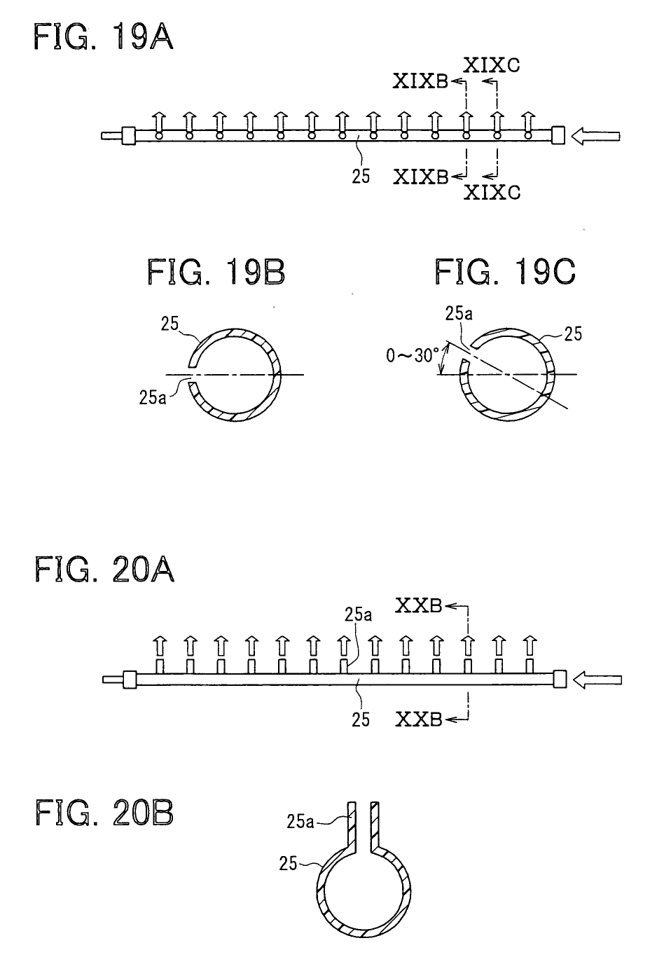

The jet flow blowing-out pipe 25 according to an eighth embodiment of the present invention will be described with reference to FIGS. 19A-19C. Differences between the eighth embodiment and the above-described embodiments will be explained.

In this case, the jet holes 25a having different jet angles are arrayed at the jet flow blowing-out pipe 25. The different jet angles (of jet holes 25a) can be alternately arranged in the longitudinal direction of the jet flow blowing-out pipe 25.

As shown in FIGS. 19B and 19C, the jet angle can be defined between the jet direction of the jet flow F and a horizontal surface, for example. That is, the jet flow blowing-out pipe 25 is provided with the jet holes 25a which have openings at different positions in the circumferential direction of the jet flow blowing-out pipe 25.

Thus, the deviation of the jet angle can be absorbed, so that the turbulence M of the air flow can be generated in a wide range. Therefore, a stable effect can be obtained.

### Ninth Embodiment

The jet flow blowing-out pipe 25 according to a ninth embodiment of the present invention will be described with reference to FIGS. 20A-20B. Differences between the ninth embodiment and the above-described embodiments will be explained.

In this case, as shown in FIGS. 20A-20B, the jet hole 25a of the jet flow blowing-out pipe 25 is a substantially cylindrical hole. That is, the jet hole 25a can be defined by a substantially cylindrical portion which protrudes from the outer surface of the jet flow blowing-out pipe 25. Thus, the directivity of the blowing-out jet flow F can be improved.

### Tenth Embodiment

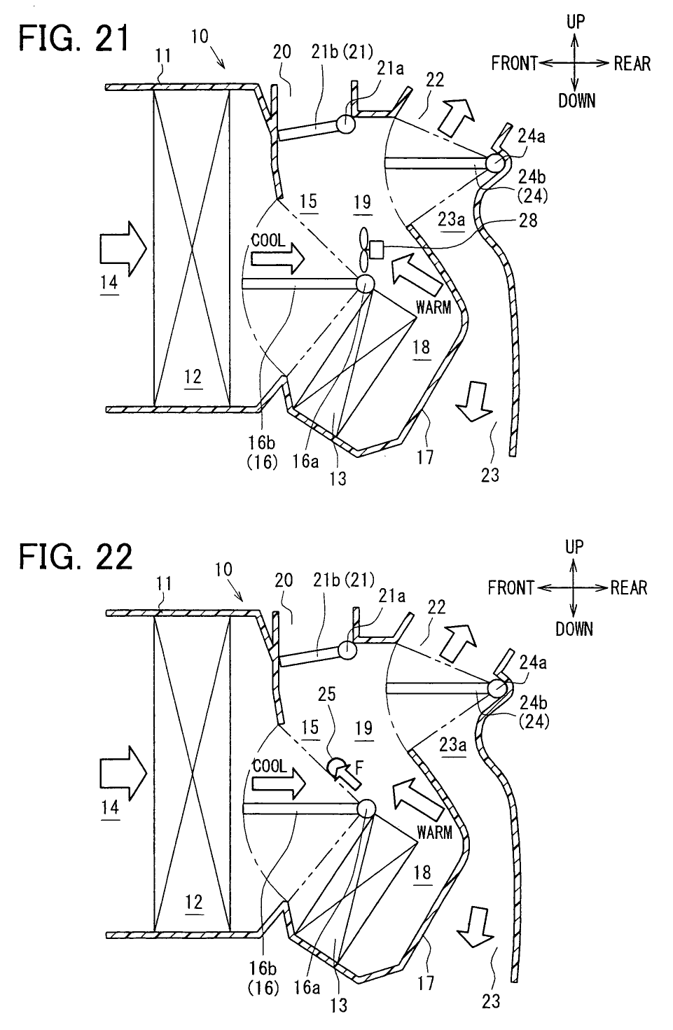

The air conditioning unit 10 according to a tenth embodiment of the present invention will be described with reference to FIG. 21. Differences between the tenth embodiment and the above-described embodiments will be explained.

According to this embodiment, a small-sized air-blowing unit 28 is arranged in the air conditioning casing 11 to generate air flow. In this case, the small-sized air-blowing unit 28 such as a small-sized fan can be arranged in the vicinity of the cool-warm air mixing space 19 to generate the air flow.

Moreover, because the angle (of cool air) in which cool air flows into the cool-warm air mixing space 19 varies according to the opening degree of the air mixing door 16, it is effective to change the blowing-out direction of air from the small-sized air-blowing unit 28 corresponding to the turn position of the air mixing door 16.

### Eleventh Embodiment

The air conditioning unit 10 according to an eleventh embodiment of the present invention will be described with reference to FIG. 22. Differences between the eleventh embodiment and the above-described embodiments will be explained.

According to this embodiment, for example, in the air mixing state where the air mixing door 16 is positioned at the intermediate position between the maximum bypass position and the maximum heating position, air in the vicinity of the generation end (at which interface K between cool air and warm air caused in cool-warm air mixing space 19 is generated) of the interface K is sucked.

In this manner, the turbulence M of the air flow becomes large in area and pushed up to be carried on the interface K, by sucking air in the vicinity of the interface K between cool air and warm air generated in the cool-warm air mixing space 19, and hence in the vicinity of the generation end (i.e., upstream end) of the interface K as possible. Therefore, the adequate mixing of the air flow can be obtained.

Accordingly, unlike the case where the ribs and the like are provided to construct the resistance members, it is capable to improve the mixing between cool air and warm air without increasing the ventilation resistance.

Because the angle of cool air flowing into the cool-warm air mixing space 19 varies according to the opening degree of the air mixing door 16, it is effective to vary the suction direction corresponding to the turn position of the air mixing door 16.

Thereby, the temperature distribution in blowing-out ports can become even and the temperature difference among the blowing-out ports can become liable to be controlled, so that it is capable to obtain a favorable performance of temperature control in all of the blowing-out modes.

In this case, a negative pressure generating unit can be provided in the air conditioning unit 10. Thus, a negative pressure generated in the negative pressure generating unit can be led to suck air in the vicinity of the interface K.

For example, the negative pressure can be obtained by an aspirator as the negative pressure generating unit. Alternatively, the negative pressure generated in a vehicle engine can be led for the suction of air in the vicinity of the interface K. Thus, the negative pressure generated in the vehicle engine can be used.

### Twelfth Embodiment

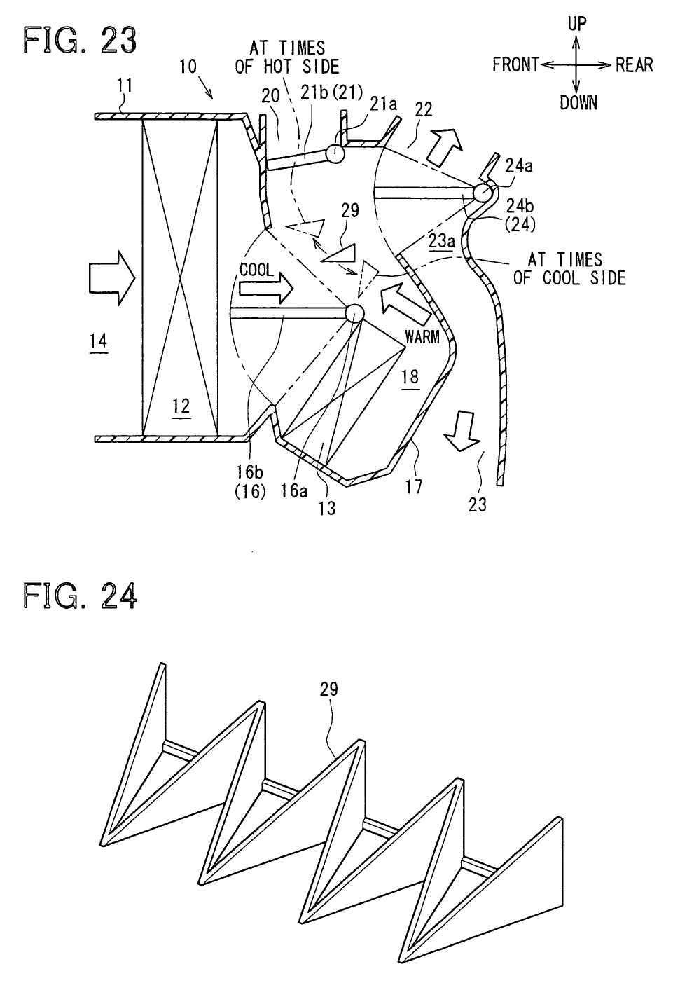

The air conditioning unit 10 according to a twelfth embodiment of the present invention will be described with reference to FIGS. 23 and 24. Differences between the twelfth embodiment and the above-described embodiments will be explained.

According to this embodiment, as shown in FIG. 23, a turbulence generating member 29 (of moving type, for example) is arranged at the interface K between cool air and warm air generated in the cool-warm air mixing space 19, for example, in the air mixing state where the air mixing door 16 is arranged at the intermediate position between the maximum bypass position and the maximum heating position.

As shown FIG. 24, the turbulence generating member 29 can be constructed by resin-molding, for example. In this case, by arranging the turbulence generating member 29 at the interface K between cool air and warm air generated in the cool-warm air mixing space 19, the turbulence M of the air flow is increased in area and the turbulence M of the air flow is generated at the interface K. Therefore, the adequate mixing of the air flow can be obtained.

Accordingly, unlike the case where the ribs are provided as the resistance members to forcedly change the flow direction, it is capable to improve the mixing between cool air and warm air without significantly increasing the ventilation resistance.

Thereby, the temperature distribution in the blowing-out ports can become even and the temperature difference among the blowing-out ports becomes liable to be controlled, so that a favorable performance of the temperature control can be obtained at all of the blowing-out modes.

Moreover, the position and posture of the turbulence generating member 29 is made variable corresponding to the turn position of the air mixing door 16. Thus, because the angle of cool air flowing into the cool-warm air mixing space 19 is varied according to the opening degree of the air mixing door 16 and the position of the interface K is changed, it is effective to vary the position and posture of the turbulence generating member 29 in response to the turn position of the air mixing door 16.

Therefore, the mixing between cool air and warm air can be improved in the whole air mixing region, without significantly increasing the ventilation resistance. The position and posture of the turbulence generating member 29 can be interlocked with the air mixing door 16. Alternatively, the position and posture of the turbulence generating member 29 can be singly driven to be used in the adjustment of the up-down-direction temperature difference. More alternatively, the position and posture of the turbulence generating member 29 can be changed by swinging.

### Other Embodiments

Although the present invention has been fully described in connection with the preferred embodiments thereof with reference to the accompanying drawings, it is to be noted that various changes and modifications will become apparent to those skilled in the art.

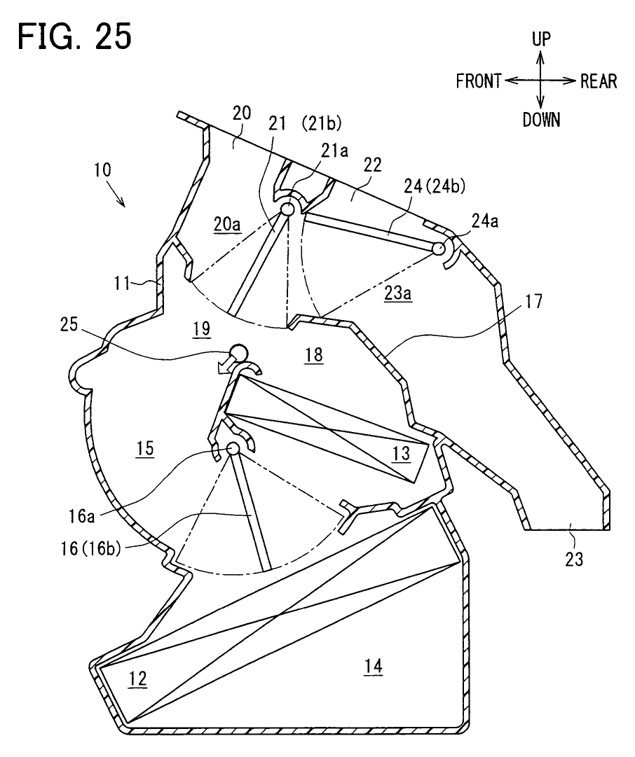

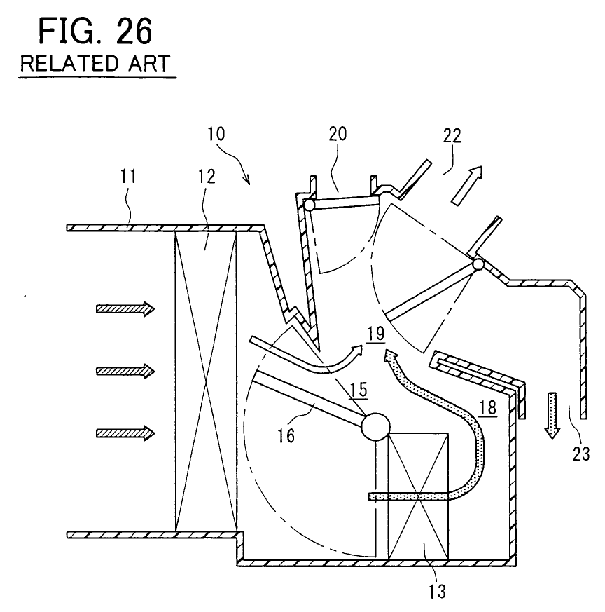

The air conditioning unit 10 can be arranged in the vehicle with respect to the front-rear direction, the left-right direction and the up-down direction of the vehicle as described above. However, the air conditioning unit 10 can be also arranged in the vehicle with other orientation. For example, as shown in FIG. 25, the air conditioning unit 10 can be also provided with the horizontally-laid type evaporator 12 in which air-conditioning air flows from the lower side to the upper side. The reference numerals in FIG. 24 correspond to those in the embodiments described above.

Moreover, the jet hole 25a can be constructed of a circular hole, or a rectangular hole, or a triangular hole, or a hole having other shape. Furthermore, the jet hole 25a is not limited in diameter and number.

Moreover, in the above-described embodiment, the respective doors 16, 21 and 24 are operated through the linkage by the actuator such as the servomotor. However, the door 16, 21 and 24 can be also operated through an operating cable or the like by a manually operating force which is applied to a manually operated member such as a temperature control lever or a blowing-out mode lever, which is provided at the air conditioning operation panel.

Furthermore, in the air conditioning unit 10 of the air conditioner, the evaporator 12 can be also omitted.

Moreover, in addition to the foot opening 23 for blowing warm air toward a front seat of the vehicle, a foot opening for a rear seat of the vehicle can be also added to blow out warm air toward the lower portion of a passenger at the rear seat in the passenger compartment.

Such changes and modifications are to be understood as being in the scope of the present invention as defined by the appended claims.

What is claimed is:

1. An air conditioner for a vehicle, comprising:
an air conditioning casing for defining therein a passage of air;
a heating heat exchanger, which is arranged in the air conditioning casing to heat air; and
an air mixing door which is arranged at an air upstream side of the heating heat exchanger to adjust an air volume ratio between air passing the heating heat exchanger and air passing a cool air bypass passage,
the cool air bypass passage through which air flows to bypass the heating heat exchanger being defined in the air conditioning casing, wherein:
the air conditioning casing has therein a cool-warm air mixing space, in which cool air supplied through the cool air bypass passage and warm air heated by the heating heat exchanger and supplied through a warm air passage are mixed;
the air conditioning casing has a defroster opening, a face opening and a foot opening, through which mixed air from the cool-warm air mixing space flows outward into a passenger compartment of the vehicle,
the defroster opening, the face opening and the foot opening being positioned from a side of the cool air bypass passage to a side of the warm air passage; and
in an air mixing state where the air mixing door is arranged at a substantially intermediate position between a maximum bypass position and a maximum heating position, an additional air flow is compulsorily caused in the vicinity of a generation end of an interface between the cool air and the warm air which is generated in the cooling-warm air mixing space.

2. The air conditioner according to claim 1, wherein
an air flow is jetted toward the generation end of the interface between the cool air and the warm air which is generated in the cool-warm air mixing space, to cause the additional air flow in the vicinity of the generation end.

3. The air conditioner according to claim 2, wherein
the air flow is jetted in such a manner that the air flow is opposite to the cool air which flows into the cool-warm air mixing space.

4. The air conditioner according to claim 2, wherein
the air flow is jetted in such a manner that the air flow is opposite to the warm air which flows into the cool-warm air mixing space.

5. The air conditioner according to claim 3, wherein
an opposing angle is substantially in a range of 0-30 degrees, the opposing angle being between the air flow and the cool air in the case where the air flow is jetted with opposing the cool air, and being between the air flow and the warm air in the case where the air flow is jetted with opposing the warm air.

6. The air conditioner according to claim 3, wherein
a flow velocity of the air flow is substantially in a range of 1-3 times a wind velocity, the wind velocity being of the cool air in the case where the air flow is jetted with opposing the cool air, and being of the warm air in the case where the air flow is jetted with opposing the warm air.

7. The air conditioner according to claim 2, wherein
the air flow is jetted, with a wind velocity of the air flow being variable.

8. The air conditioner according to claim 2, wherein
a jet direction of the air flow is variable in response to a turn position of the air mixing door, the air flow being jetted in the jet direction.

9. The air conditioner according to claim 2, further comprising:
an air blower unit for blowing air toward an air conditioning unit which is constructed by the air conditioning casing, the heating heat exchanger and the air mixing door; and
a branch ventilation passage member, wherein
a part of air which is blown toward the air conditioning unit from the air blower unit is guided by the branch ventilation passage member to the generation end of the interface, to constitute the air flow.

10. The air conditioner according to claim 2, further comprising:
a cooling heat exchanger which is arranged in the air conditioning casing to cool air; and
a branch ventilation passage member, wherein
a part of air which flows toward the cooling heat exchanger is guided by the branch ventilation passage member to the generation end of the interface, to constitute the air flow.

11. The air conditioner according to claim 2, further comprising
a branch ventilation passage member, wherein
an air flow generated by an air flow generating source of an exterior is led by the branch ventilation passage member, to be jetted toward the generation end of the interface.

12. The air conditioner according to claim 2, wherein
the air flow is jetted from a shaft portion of the air mixing door.

13. The air conditioner according to claim 2, further comprising
a jet flow blowing-out member having a plurality of small holes, through which the air flow is jetted.

14. The air conditioner according to claim 13, wherein the holes which have different jet angles are arrayed at the jet flow blowing-out member.

15. The air conditioner according to claim 13, wherein
the hole through which the air flow is jetted has a substantially cylindrical shape.

16. The air conditioner according to claim 2, further comprising
a small-sized air-blowing unit which is arranged in the air conditioning casing to generate the air flow.

17. The air conditioner according to claim 1, wherein
air in the vicinity of the generation end of the interface between the cool air and the warm air which is generated in the cool-warm air mixing space is sucked, to cause the additional air flow at the generation end.

18. The air conditioner according to claim 17, further comprising
a negative pressure generating unit for generating a negative pressure in the air conditioning casing, the negative pressure being led to suck air in the vicinity of the generation end of the interface.

19. The air conditioner according to claim 17, wherein
a negative pressure generated in an engine of the vehicle is led to suck air in the vicinity of the generation end of the interface.

20. The air conditioner according to claim 1, further comprising
a turbulence generating member which is arranged at the interface between the cool air and the warm air generated in the cool-warm air mixing space, wherein
the turbulence generating member causes the additional air flow in the vicinity of the generation end of the interface.

21. The air conditioner according to claim 20, wherein
a position and a posture of the turbulence generating member is variable in response to a turn position of the air mixing door.

22. The air conditioner according to claim 13, wherein
the jet flow blowing-out member is rotatably supported at the air conditioning casing, and positioned at an immediately upper side of a shaft portion of the air mixing door.
